(19) United States
(12) Patent Application Publication
(10) Pub. No.: US 2017/0164099 A1
(43) Pub. Date: Jun. 8, 2017

(54) GIMBAL-MOUNTED ULTRASONIC SPEAKER FOR AUDIO SPATIAL EFFECT

(71) Applicant: Sony Corporation, Tokyo (JP)

(72) Inventors: Peter Shintani, San Diego, CA (US); Gregory Peter Carlsson, Santee, CA (US); Morio Usami, Tokyo (JP); Kiyoto Shibuya, Saitama City (JP); Norihiro Nagai, Yokohama (JP); Masaomi Nishidate, Tokyo (JP)

(21) Appl. No.: 14/968,349

(22) Filed: Dec. 14, 2015

Related U.S. Application Data
(60) Provisional application No. 62/264,660, filed on Dec. 8, 2015.

(51) Int. Cl. H04R 1/34; H04R 9/06; H04R 1/02

(52) U.S. Cl. CPC H04R 1/345; H04R 1/02; H04R 9/06

(57) ABSTRACT

Audio spatial effects are provided using a gimbal-mounted ultrasonic speaker, with the azimuth angle and, if desired, elevation angle of a gimbal assembly on which one or more ultrasonic speakers are mounted being established in response to a control signal from, e.g., a game, console or video player.

### TECHNICAL FIELD

The application relates generally to gimbal-mounted ultrasonic speakers for producing audio spatial effects.

### BACKGROUND

Audio spatial-effects to model the movement of a sound-emitting video object as if the object were in the space in which the video is being displayed are typically provided using multiple speakers and phased-array principles. As understood herein, such systems may not as accurately and precisely model audio spatial effects or be as compact as is possible using present principles.

### SUMMARY

An apparatus includes at least one ultrasonic speaker configured to emit sound along a some axis, a gimbal assembly coupled to the ultrasonic speaker, and at least one computer memory that is not a transitory signal and that comprises instructions executable by at least one processor to receive a control signal. Responsive to the control signal, the gimbal assembly is actuated to move the speaker such that the sound axis moves azimuthally.

The instructions may be executable to, responsive to the control signal, actuate the gimbal assembly to move the speaker such that the sound axis changes in elevation angle. The control signal may be received from a computer game console, or it may be received responsive to a determination that a face image matches a template image, in which case the control signal causes actuation of the gimbal assembly to direct the sonic axis toward a location corresponding to the face image. In this latter embodiment, the instructions may be executable to receive indication of the template image from a user interface (UI).

The control signal can represent at least one audio effect data in a received audio channel. The audio effect data can be established at least in part from input to a computer game input device.

In examples, the control signal is received from a computer game console outputting a main audio channel for playing on non-ultrasonic speakers. Responsive to the control signal, the instructions can be executable to move the speaker to direct sound to a location associated with a listener. The instructions can be executable to direct sound at a reflection location such that reflected sound arrives at the location associated with the listener.

In an aspect, a method includes receiving at least one control signal representing an audio effect, and actuating a gimbal assembly to move an ultrasonic speaker at least in part based on the control signal.

In an aspect, a device includes at least one computer memory that is not a transitory signal and that comprises instructions executable by at least one processor to receive a control signal, and responsive to the control signal, actuate a gimbal assembly to move an ultrasonic speaker azimuthally.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a block diagram of another system that cats use the components of FIG. 1;

FIG. 3 is a schematic diagram of an example ultrasonic speaker system mounted on a gimbal assembly;

FIGS. 4 and 5 are flow charts of example logic attendant to the system in FIG. 3;

FIG. 6 is a flow chart of example alternate logic for directing the sonic beam toward a particular viewer; and

FIG. 7 is an example screen shot tor inputting a template for the logic of FIG. 6 to employ.

### DETAILED DESCRIPTION

This disclosure relates generally to computer ecosystems including aspects of consumer electronics (CE) device networks. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozila or other browser program that can access web applications hosted by the internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony Playstation (trademarked), a personal computer, etc.

Information may he exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interlaces herein can include various sub-routines, procedure etc. Without limiting the disclosure, logic stated to be executed by a particular module can be redistributed to other software modules and/or combined together in a single module and/or made available in a shareable library.

Present principles described herein can fee implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such, as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

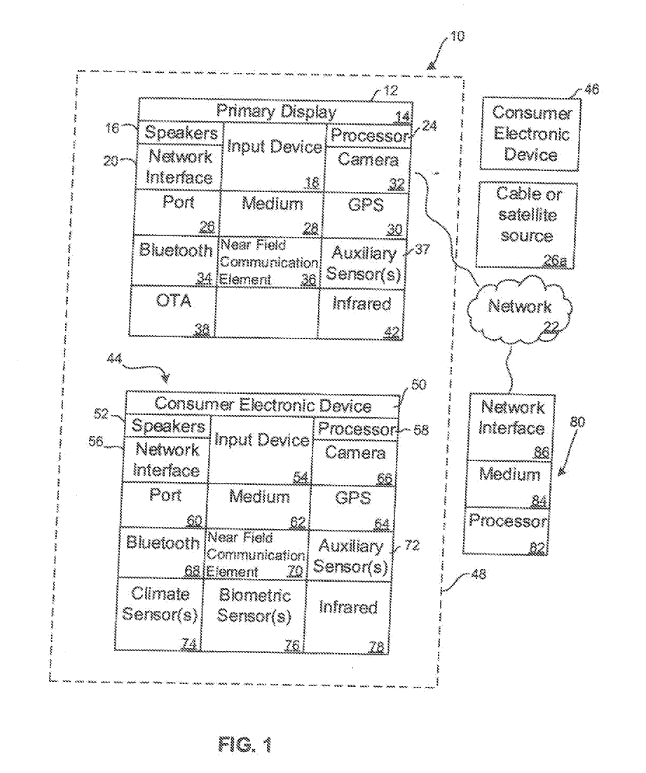

Now specifically referring to FIG. 1, an example ecosystem 10 is shown, which may include one or more of the example devices mentioned above and described further below in accordance with present principles. The first of the example devices included is the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). However, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized internet-enabled music player, computerized Internet-enabled bead phones, a computerized Internet-enabled implantable device such as an implantable skin device, game console, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interlace 20 may be, without limitation, a Wi-Fi transceiver, which is an example of a wireless computer network interface, such as but not limited to a mesh network transceiver. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below.

The AVDD 12 may further include one or more computer memories 28 such as disk-based or solid state storage that are not transitory signals, in some cases embodied in the chassis of the AVDD as standalone devices or as a personal video recording device (PVR) or video disk player either internal or external to the chassis of the AVDD for playing back AV programs or as removable memory media. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include an over-the-air TV broadcast port 38 for receiving OTH TV broadcasts providing input to the processor 24. In addition to the foregoing, it is noted, that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. When the system 10 is a home network, communication between components may be according to the digital living network alliance (DLNA) protocol.

In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller, and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVDD 12, or if may be a more sophisticated device such as a tablet computer, a game controller communicating via wired or wireless link with a game console implemented by the second CE device 46 and controlling video game presentation on the AVDD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 42 such as an IR data association (IRDA) device. A battery (not shown) may be provided for powering the first CE device 44. The CE device 44 may communicate with the AVDD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modern or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

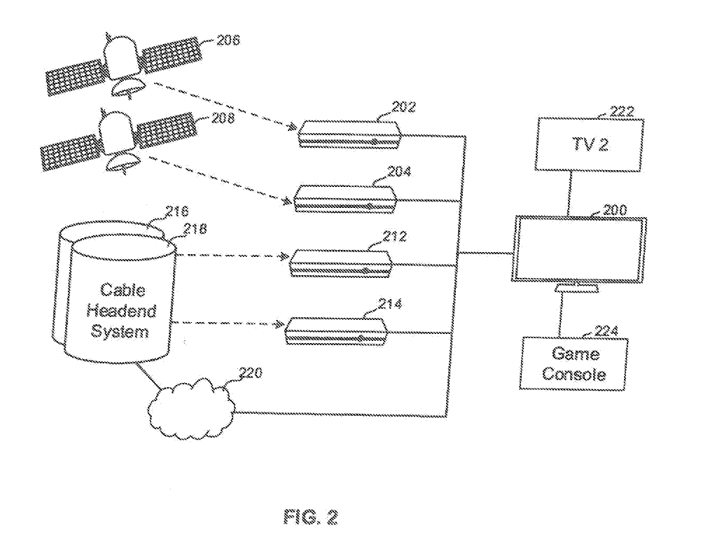

Now referring to FIG. 2, an AVDD 200 that may incorporate some or all of the components of the AVDD 12 in FIG. 1 is connected to at least one gateway for receiving content, e.g., UHD content such as 4K or 8K content, from the gateway. In the example shown, the AVDD 200 is connected to first and second satellite gateways 202, 204, each of which may be configured as a satellite TV set top box for receiving satellite TV signals from respective satellite systems 206, 208 of respective satellite TV providers.

In addition or in lieu of satellite gateways, the AVDD 200 may receive content from one or more cable TV set top box-type gateways 210, 212, each of which receives content from a respective cable head end 214, 216.

Yet again, instead of set-top box like gateways, the AVDD 200 may receive content from a cloud-based gateway 220. The cloud-based gateway 220 may reside in a network interface device that is local to the AVDD 200 (e.g., a modem of the AVDD 200) or it may reside in a remote Internet server that sends Internet-sourced content to the AVDD 200. In any case, the AVDD 200 may receive multimedia content such as UHD content from the Internet through the cloud-based gateway 220. The gateways are computerized and thus may include appropriate components of any of the CE devices shown in FIG. 1.

In some embodiments, only a single set top box-type gateway may be provided using, e.g., the present assignee's remote viewing user interface (RVU) technology.

Tertiary-devices may be connected, e.g., via Ethernet or universal serial bus (USB) or WiFi or other wired or wireless protocol to the AVDD 200 in a home network (that may be a mesh-type network) to receive content from the AVDD 200 according to principles herein. In the non-limiting example shown, a second TV 222 is connected to the AVDD 200 to receive content therefrom, as is a video game console 224. Additional devices may be connected to one or more tertiary devices to expand the network. The tertiary devices may include appropriate components of any of the CE devices shown in FIG. 1.

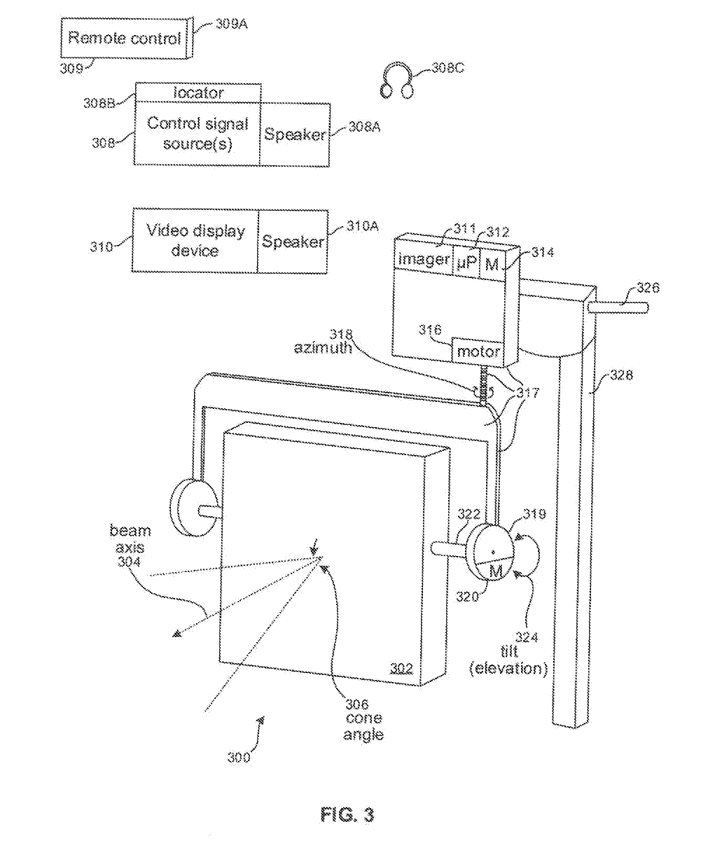

In the example system of FIG. 3, the control signal may come from a game console implementing some or all of the components of the CE device 44, or from a camera such as one of the cameras discussed herein, and the gimbal assembly may include, in addition to the described mechanical parts, one or more the components of the second CE device 46. The game console may output video on the AVDD. Two or more of the components of the system may he consolidated into a single unit.

With greater specificity, a system 300 in FIG. 3 includes an ultrasonic speaker 302 (also known as a “parametric emitter”) that emits sound along a sonic axis 304. Multiple US speakers, e.g., arranged in a spherical assembly, may be mounted on the gimbal assembly. The sound beam is typically confined to relatively narrow cone defining a cone angle 306 about the axis 304 typically of a few degrees up to, e.g., thirty degrees. Thus, the speaker 302 is a directional sound source that produces a narrow beam of sound by modulating an audio signal onto one or more ultrasonic carrier frequencies. The highly directional nature of the ultrasonic speaker allows the targeted listener to hear the sound clearly, while another listener in the same area, but outside of the beam hears very little of the sound.

As mentioned above, a control signal for moving the speaker 302 may be generated by, is examples, one or more control signal sources 308 such as cameras, game consoles, personal computers, and video players in, e.g., a home entertainment system that output related video on a video display device 310. By this means, sound effects such as a vehicle (plane, helicopter, car) moving through a space can be achieved with a great degree of accuracy using only a single speaker as a sound source.

In an example, the control signal source 308 such as a game controller may output the main audio on a main, non-ultrasonic speakers) 308A or 310A of e.g., a video display-device such as a TV or PC or associated home sound system that the game is being presented on. A separate sound effect audio channel may be included in the game, and this second sound effect audio channel is provided to the US speaker 300 along with or as part of the control signal sent to move the gimbal assembly, for playing the sound effect channel on the directional US speaker 300 while the main audio of the game is simultaneously played on the speakers) 308A/310A.

The control signal source 308 may receive user input from one or more remote controllers (RC) 309 such as computer game RCs. The RC 309 and/or sound headphone 308C provided for each game player for playing the main (non-US) audio may have a locator tag 309A appended to it such as an ultra-wide band (UWB) tag by which the location of the RC and/or headphones can be determined. In this way, since the game software knows which headphones/RC each player has, it can know the location of that player to aim the US speaker at for playing US audio effects intended for that player.

Instead of UWB, other sensing technology that can be used with triangulation to determine the location of the RC may be used, e.g., accurate Bluetooth or WiFi or even a separate GPS receiver. When imaging is to be used to determine the location of the user/RC and/or room dimensions as described further below, the control signal source 308 may include a locator 308B such as a camera (e.g., a CCD) or a forward looking infrared (FLIR) imager.

User location may be determined during an initial auto calibration process. Another example of such a process is as follows. The microphone in the head set of the game player can be used or alternatively a microphone incorporated into the ear pieces of the headset or the earpiece itself could be used as a microphone. The system can precisely calibrate the location of each ear by moving the US beam around until a listener wearing the headphones indicates, e.g., using a predetermined gesture, which ear is picking up the narrow US beam.

In addition or alternatively the gimbal assembly may be coupled to a camera or FLIR imager 311 which sends signals to one or more processors 312 accessing one or more computer memories 314 in a gimbal assembly. The control signal (along with, if desired, the sound effect audio channel) is also received (typically through a network interface) by processor. The gimbal assembly may include an azimuth control motor 316 controlled by the processor 312 to turn a support assembly 317 on which the speaker 302 is mounted in an azimuthal dimension 318 as shown.

If desired, not only the azimuth of the sonic beam 304 but also its elevation angle with respect to the horizontal plane may be controlled. In the example shown, the support assembly 317 includes opposed side mounts 319, and an elevation control motor 320 may be coupled to a side mount 319 to rotate an axle 322 coupled to the speaker 302 to tilt the speaker up and down in elevation angle, as indicated at 324. The gimbal assembly may include a horizontal support arm 326 coupled to a vertical support pole 328 in non-limiting examples.

The gimbal assembly and/or portions thereof may be a brushless gimbal assembly available from Bobby King.

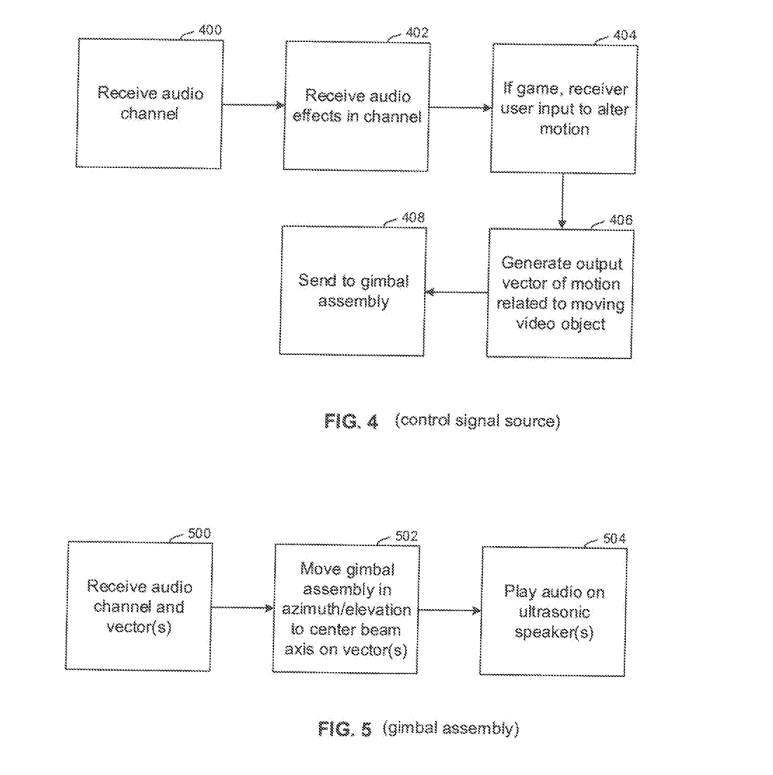

Turning to FIG. 4 for a first example, a computer game designer may designate an audio effects channel in addition to a main audio channel which is received at block 400 to specify a location (azimuth and, if desired, elevation angle) of the audio effects carried in the audio effects channel and received at block 402. This channel typically is included in the game software (or audio-video movie, etc.). When the control signal for the audio effects is from a computer game software, user input to alter motion of an object represented by the audio effects during the game (position, orientation) may be received from the RC 309 at block 404. At block 406 the game software generates and outputs a vector (x-y-z) defining the position of the effect over time (motion) within the environment. This vector is sent to the gimbal assembly at block 408 such that the ultrasonic speakers) 300 of the gimbal assembly plays back the audio effect channel audio and uses the vector to move the speaker 302 (and, hence, the sonic axis 304 of the emitted audio effect).

FIG. 5 illustrates what the gimbal assembly does with the control signal. At block 500 the audio channel with directional vectors) is received. Proceeding to block 502, the gimbal assembly is moved to move the speaker 302 in azimuth and/or elevation angle to center the sonic axis 304 in the demanded vector. The demanded audio is played on the speaker at block 504, confined within the cone angle 306.

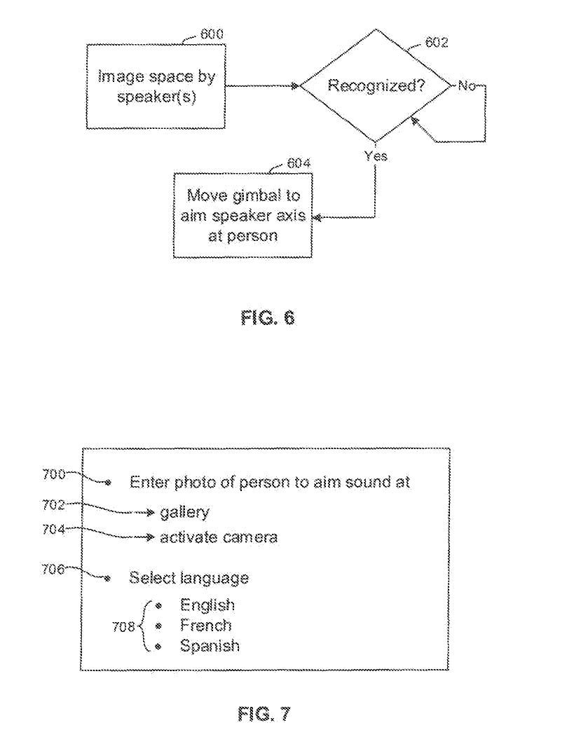

As alluded to above, a camera such as the one shown in FIG. 1 may be used to image a space in which the speaker 302 is located at block 600 of FIG. 6, representing logic that may be employed by the processor of the gimbal assembly, for example. While the camera in FIG. 1 is shown coupled to an audio video display device, it may alternatively be the locator 308B provided on the game console serving as the control signal generator 308 or the imager 311 on the gimbal assembly itself. In any case, it is determined at decision diamond 602, using face recognition software operating on a visible image from, e.g., the locator 308B or imager 311, whether a predetermined person is in the space by, e.g., matching an image of the person, against a stored template image, or by determining, when FLIR is used, whether an IR signature matching a predetermined template has been received. If a predetermined person is imaged, the gimbal assembly may be moved at block 604 to aim the sonic axis 304 at the recognized speaker.

To know where the imaged face of the predetermined person is, one of several approaches may be employed. A first approach is to instruct the person using an audio or video prompt to make a gesture such as a thumbs up or to hold up the RC in a predetermined, position when the person hears audio, and then move the gimbal assembly to sweep the sonic axis around the room until the camera, images the person making the gesture. Another approach is to preprogram the orientation of the camera axis into the gimbal assembly so that the gimbal assembly, knowing the central camera axis, can determine any offset from the axis at which the face is imaged and match the speaker orientation to that offset. Still further, the camera 311 itself maybe mounted on the gimbal assembly in a fixed relationship with the sonic axis 304 of the speaker 302, so that the camera axis and sonic axis always match. The signal from the camera can be used to center the camera axis (and hence sonic axis) on the imaged face of the predetermined person.

FIG. 7 presents an example user interface (UI) that may be used to enter the template used at decision diamond 602 in FIG. 6. A prompt 700 can be presented on a display such as a video display to which a game controller is coupled for a person to enter a photo of a person at whom the sonic axis should be aimed. For instance, a person with sight and/or hearing disabilities may be designated as the person at whom to aim the speaker 302.

The user may be given an option 702 to enter a photo in a gallery, or an option 704 to cause the camera to image a person, currently in front of the camera. Other example means for entering the test template for FIG. 6 may be used. For example, the system may be notified fey direct user input where to aim the sonic axis 304 of the speaker 302.

In any case, it may be understood that present principles may be used to deliver video description audio service to a specific location where the person who has a visual disability may be seated.

Another characteristic of the ultrasonic speaker is that if aimed at a reflective surface such as a wall, the sound appears to come from the location of the reflection. This characteristic may be used as input to the gimbal assembly to control the direction of the sound using an appropriate angle of incidence off the room boundary to target the reflected sound at the user. Range finding technology may be used to map the boundaries of the space. Being able to determine objects in the room, such as curtains, furniture, etc. would aid in the accuracy of the system. The addition of a camera, used to map or otherwise analyze the space in which the effects speaker resides can be used to modify the control signal in a way that improves the accuracy of the effects by taking the environment into account.

With greater specificity, the room may be imaged by any of the cameras above and image recognition implemented to determine where the walls and ceiling are. Image recognition can also indicate whether a surface is a good reflector, e.g., a flat white surface, typically is a wall that reflects well, while a folded surface may indicate a relatively non-reflective curtain. A default room configuration (and if desired default locations assumed for the listener(s)) may be provided and modified using the image recognition technology.

Alternatively, the directional sound from the US speaker 300 may be used by moving the gimbal assembly, emitting chirps at each of various gimbal assembly orientations, and timing reception of the chirps, know (1) the distance to the reflective surface in that direction and (2) based on the amplitude of the return chirp, whether the surface is a good or poor reflector. Yet again, white noise may be generated as a pseudorandom (PN) sequence and emitted by the US speaker and reflections then measured to determine the transfer function of US waves for each direction in which the “test” white noise is emitted. Yet further, the user may be prompted through a series of UIs to enter room dimensions and surface types.

Still again, one or more of the room dimension mapping techniques described in USPP 2015/0256954, incorporated herein by reference, may be used.

Or, structured light could be employed to map a room in 3D for more accuracy. Another way to check the room, is the use an optical pointer (known divergence), and with a camera, it can accurately measure the room dimensions. By the spot dimensions, and distortions, the angle of incidence on a surface can be estimated. Also the reflectivity of the surface is an additional hint as to whether it may or may not be a reflective surface for sound.

In any case, once the room dimensions and surface types are known, the processor of the gimbal assembly, knowing, from the control signal, the location at which audio effects are modeled to come and/or be delivered to, can through triangulation determine a reflection location, at which to aim the US speaker 300 so that the reflected sound from the reflection location is received at the intended location in the room. In this manner the US speaker 300 may not be aimed by the gimbal assembly directly at the intended player but instead may be aimed, at the reflection point, to give the intended player the perception that the sound is coming from the reflection point and not the direction of the US speaker.

FIG. 7 illustrates a further application, in which multiple ultrasonic speakers on one or more gimbal assemblies provide the same audio but in respective different language audio tracks such as English and French simultaneously as fee audio is targeted. A prompt 706 can be provided to select the language for the person whose facial image establishes the entered template. The language may be selected from a list 708 of languages and correlated to the person's template image, such that during subsequent operation, when a predetermined face is recognized at decision diamond 602 in FIG. 6, the system knows which language should be directed to each user. Note that while the gimbal-mounted ultrasonic speaker precludes the need for phased array technology, such technology may be combined with present principles.

The above methods may be implemented as software instructions executed by a processor, including suitably configured application specific integrated circuits (ASIC) or field programmable gate array (FPGA) modules, or any other convenient manner as would be appreciated by those skilled in those art. Where employed, the software instructions may be embodied in a device such as a CD Rom or Flash drive or any of the above non-limiting examples of computer memories that are not transitory signals. The software code instructions may alternatively be embodied in a transitory arrangement such as a radio or optical signal, or via a download over the internet.

It will be appreciated that whilst present principals have been described with reference to some example embodiments, these are not intended to be limiting, and that various alternative arrangements may be used to implement the subject matter claimed herein.

1. Apparatus comprising:
at least one ultrasonic speaker configured to emit sound along a sonic axis, the sound being a sound effect in an ultrasonic range emulating sound from a moving object in a computer game;
a gimbal assembly coupled to the ultrasonic speaker;
at least one non-ultrasonic speaker configured for playing non-sound effect audio from the computer game;
at least one computer memory that is not a transitory signal and that comprises instructions executable by at least one processor to:
receive a control signal; and
responsive to the control signal, actuate the gimbal assembly to move the speaker such that the sound axis moves azimuthally.

2. The apparatus of claim 1, comprising the processor.

3. The apparatus of claim 1, wherein the instructions are executable to:
responsive to the control signal, actuate the gimbal assembly to move the speaker such that the sound axis changes in elevation angle.

4. The apparatus of claim 1, wherein the control signal is received from a computer game console outputting a main audio channel for playing on the non-ultrasonic speaker.

5. The apparatus of claim 1, wherein responsive to the control signal, the instructions are executable to move the speaker to direct sound to a location associated with a listener.

6. The apparatus of claim 5, wherein the instructions are executable to direct sound at a reflection location such that reflected sound arrives at the location associated with the listener.

7. The apparatus of claim 1, wherein the control signal represents at least one audio effect data in a received audio channel.

8. The apparatus of claim 7, wherein the audio effect data is established at least in part from input to a computer game input device.

9. A method comprising:
receiving at least one control signal representing an audio effect emulating a moving object in a computer game; and
actuating a gimbal assembly to move an ultrasonic speaker at least in part based on the control signal.

10. The method of claim 9, wherein the ultrasonic speaker is configured to emit sound along a sonic axis, and the control signal causes the gimbal assemble to move the speaker such that the sound axis moves azimuthally.

11. The method of claim 9, wherein the ultrasonic speaker is configured to emit sound along a sonic axis, and the control signal causes the gimbal assemble to move the speaker such that the sound axis changes in elevation angle.

12. The method of claim 9, comprising moving the speaker to direct sound to a location associated with a listener.

13. The method of claim 9, wherein the audio effect is established at least in part from input to a computer game input device.

14. Device comprising:
a gimbal assembly; and
at least one computer memory that is not a transitory signal and that comprises instructions executable to:
receive a control signal; and
responsive to the control signal, actuate the gimbal assembly to move an ultrasonic speaker azimuthally, the gimbal assembly being coupled to an imaging device which sends signals to at least one processor in the gimbal assembly, the processor configured to control an azimuth control motor to turn a support assembly on which the speaker is mounted in an azimuthal dimension, the support assembly comprising side mounts supporting an elevation control motor to tilt the speaker up and down in elevation angle.

15. The device of claim 14, comprising the processor.

16. The device of claim 14, wherein the instructions are executable to:
responsive to the control signal, actuate the gimbal assembly to move the speaker in elevation angle.

17. The device of claim 14, wherein responsive to the control signal, the instructions are executable to move the speaker to direct sound to a location associated with a listener.

18. The device of claim 14, wherein the control signal represents at least one audio effect data in a received audio channel from a source also outputting a main audio channel for playing on non-ultrasonic speakers.

19. The device of claim 18, wherein the audio effect data is established at least in part from input to a computer game input device outputting a main audio channel for playing on non-ultrasonic speakers.

20. The device of claim 17, wherein the instructions are executable to determine the location associated with a listener using headphones associated with a game console.
